(19) United States
(12) Patent Application Publication
(10) Pub. No.: US 2019/0003223 A1
(43) Pub. Date: Jan. 3, 2019

(54) EXTRUDED GOOSE NECK HINGE

(71) Applicant: Dura Operating, LLC, Auburn Hills, MI (US)

(72) Inventors: Indraneel Krishna Page, Rochester Hills, MI (US); Aaron Brion Stachewicz, Troy, MI (US)

(21) Appl. No.: 15/639,469

(22) Filed: Jun. 30, 2017

(51) Int. Cl. E05D 5/06; E05D 3/02

(52) U.S. Cl. CPC E05D 5/062; E05D 3/02; E05Y 2900/548; E05D 11/06; E05Y 2900/536; E05Y 2900/532; E05D 2005/067

(57) ABSTRACT

A goose neck hinge assembly for a motor vehicle includes a base portion extending from a panel attachment portion to a hinge portion. The base portion includes a rotation-resisting joint. The base portion includes a first structural element with first structural ribs. The first structural element is joined at the rotation-resisting joint to a second structural element. The second structural element includes second structural ribs. The first structural ribs and the second structural ribs are topology optimized providing bending resistance and structural reinforcement at predetermined locations. The rotation-resisting joint includes a recessed fastener. The first structural element extends from the hinge portion to the rotation-resisting joint and the second structural element extends from the rotation-resisting joint to the panel attachment portion.

### FIELD

The invention relates generally to goose neck hinges for vehicles, and more particularly to extruded goose neck hinges for attaching a trunk lid to a body of a vehicle.

### BACKGROUND

The statements in this section merely provide background information related to the present disclosure and may or may not constitute prior art.

Motor vehicles have been designed with a variety of different closures such as a deck lid to open and close a rear compartment or trunk. Typically, the deck lid is attached to a vehicle body of the motor vehicle with at least one, preferably a pair of laterally spaced hinges. Currently, the deck lid hinges are of a goose-neck type for allowing motion of the deck lid from a fully open position to a fully closed position, and for counterbalancing a weight of the deck lid. Because deck lid hinges must support the weight of the deck lid, certain properties such as strength and rigidity/stiffness are desirable. However, achieving strength and stiffness targets at low overall cost often means that deck lid hinges can be quite heavy. Accordingly, there is a need in the art for an improved deck lid hinge produced by simplified production processes, and having reduced cost of production, reduced materials cost, and/or reduced weight while maintaining or improving upon rigidity and strength characteristics.

### SUMMARY

In one aspect of the present disclosure, a goose neck hinge assembly for a motor vehicle includes a base portion extending from a panel attachment portion to a hinge portion. The base portion includes a rotation-resisting joint. The base portion includes a first structural element with first structural ribs. The first structural element is joined at the rotation-resisting joint to a second structural element. The second structural element includes second structural ribs. The first structural ribs and the second structural ribs are topology optimized providing bending resistance and structural reinforcement at predetermined locations. The rotation-resisting joint includes a recessed fastener. The first structural element extends from the hinge portion to the rotation-resisting joint and the second structural element extends from the rotation-resisting joint to the panel attachment portion.

In another aspect of the present disclosure, both the first structural element and the second structural element comprise horizontal extrusions bent into a predetermined shape.

In yet another aspect of the present disclosure, the predetermined shape includes a lateral bend.

In yet another aspect of the present disclosure, the horizontal extrusions are made from aluminum.

In yet another aspect of the present disclosure, the first structural element has a first substantially straight portion and a first substantially curvilinear portion. The first substantially straight portion extends from the hinge portion to the first substantially curvilinear portion and the first substantially curvilinear portion extends from the first substantially straight portion to the rotation-resisting joint. The second structural element has a second substantially curvilinear portion and a second substantially straight portion. The second substantially curvilinear section extends from the rotation-resisting joint to the second substantially straight portion and the second substantially straight portion extends from the second substantially curvilinear portion to the panel attachment portion.

In yet another aspect of the present disclosure the first structural ribs and the second structural ribs extend substantially from a lower surface to an upper surface of the base portion.

In yet another aspect of the present disclosure the first structural ribs include a first thickened area and the second structural ribs include a second thickened area. The first thickened area and the second thickened area are optimally located to provide structural reinforcement.

In yet another aspect of the present disclosure the first structural ribs of the first substantially curvilinear portion approximate a plurality of trusses extending substantially from the first substantially straight portion to the first thickened area and from the first thickened area to the rotation-resisting joint. The second structural ribs of the second substantially curvilinear portion approximate a plurality of trusses extending substantially from the rotation-resisting joint to the second straight portion.

In yet another aspect of the present disclosure the second structural ribs of the second substantially straight portion include a plurality of supports transverse to a longitudinal aspect of the second substantially straight portion, and the second structural ribs extend from the second substantially curvilinear portion to the second thickened area and from the second thickened area to the panel attachment portion.

In yet another aspect of the present disclosure the second thickened area is optimally located to provide structural reinforcement where the second substantially straight portion of the goose neck hinge assembly abuts the second substantially curvilinear portion.

In yet another aspect of the present disclosure the recessed fastener includes at least one of an adhesive, or a mechanical fastener.

In yet another aspect of the present disclosure the rotation-resisting joint includes a recessed area accepting and providing rotation resistance to a mechanical fastener.

In yet another aspect of the present disclosure the rotation resisting joint further includes a first cooperating fitting and a second cooperating fitting. A first shape of a portion of each of the first cooperating fitting and the second cooperating fitting corresponds to a second shape of a portion of the other cooperating fitting for connecting the first cooperating fitting and the second cooperating fitting together.

In yet another aspect of the present disclosure the mechanical fastener includes at least one of an interference joint, a bolt, a bolt and a nut, a pin, a spring pin, or a pin with rolled over ends.

In yet another aspect of the present disclosure the goose neck hinge assembly further includes a mounting bracket mounted to the motor vehicle and rotatably connected to the hinge portion of the base portion by a hinge pin.

In yet another aspect of the present disclosure the mounting bracket is a metal extrusion or casting having an inner substantially cylindrical component concentrically and integrally extruded with an outer substantially cylindrical component and a substantially planar flange. The inner substantially cylindrical component accepts the hinge pin and the outer substantially cylindrical component is connected to the inner substantially cylindrical component by a plurality of radial ribs. The substantially planar flange extends radially outward from the outer substantially cylindrical component and has a plurality of attachment features attaching the mounting bracket to the motor vehicle.

In yet another aspect of the present disclosure a goose neck hinge assembly for a motor vehicle includes a base portion extending from a panel attachment portion to a hinge portion. The base portion includes a rotation-resisting joint. The goose neck hinge assembly further includes a mounting bracket mounted to the motor vehicle, and rotatably connected to the hinge portion of the base portion by a hinge pin. The base portion includes a first horizontally extruded structural element with first structural ribs. The first horizontally extruded structural element is joined at the rotation-resisting joint to a second horizontally extruded structural element. The second horizontally extruded structural element includes second structural ribs. The first structural element and the second structural element are topology optimized providing bending resistance and structural reinforcement at predetermined locations. The rotation-resisting joint includes a recessed fastener. The first horizontally extruded structural element extends from the hinge portion to the rotation-resisting joint and the second horizontally extruded structural element extends from the rotation-resisting joint to the panel attachment portion. The mounting bracket is an extrusion having a substantially cylindrical component integrally extruded with a substantially planar flange. The substantially cylindrical component accepts the hinge pin. The substantially planar flange extends radially outward from the substantially cylindrical component and has a plurality of attachment features for attaching the mounting bracket to the motor vehicle.

In yet another aspect of the present disclosure the first structural ribs and the second structural ribs extend for a portion of a height of the base portion.

In yet another aspect of the present disclosure the first structural ribs and the second structural ribs extend substantially from a lower surface to an upper surface of the base portion.

In yet another aspect of the present disclosure a goose neck hinge assembly for a motor vehicle includes a goose neck strap having a plurality of horizontally extruded structural elements. A first of the plurality of horizontally extruded structural elements is secured at a rotation-resisting joint to a second of the plurality of horizontally extruded structural elements. The goose neck strap extends from a panel attachment portion to a hinge portion. The goose neck hinge assembly further includes a mounting bracket mounted to the motor vehicle, and rotatably connected to the hinge portion of the goose neck strap by a hinge pin. The first of the plurality of horizontally extruded structural elements extends from the hinge portion to the rotation-resisting joint and the second of the plurality of horizontally extruded structural elements extends from the rotation-resisting joint to the panel attachment portion. The first of the plurality of horizontally extruded structural elements includes first topology optimized structural ribs, and the second of the plurality of horizontally extruded structural elements includes second topology optimized structural ribs. The rotation-resisting joint includes a recessed fastener. The mounting bracket is a metal extrusion having substantially cylindrical component integrally extruded with a substantially planar flange. The substantially cylindrical component accepts the hinge pin, and the substantially planar flange extends radially outward from the substantially cylindrical component and has a plurality of attachment features for attaching the mounting bracket to the motor vehicle.

### BRIEF DESCRIPTION OF THE DRAWINGS

The drawings described herein are for illustration purposes only and are not intended to limit the scope of the present disclosure in any way. The components in the figures are not necessarily to scale, emphasis instead being placed upon illustrating the principles of the invention. Moreover, in the figures, like reference numerals designate corresponding parts throughout the views.

FIG. 1A is a perspective side view of a goose neck hinge according to the principles of the present disclosure;

FIG. 1B is a perspective side view of a portion of an example of a goose neck hinge according to the principles of the present disclosure;

FIG. 1C is a perspective side view of a rotation-resisting joint of the goose neck hinge of FIG. 1B according to the principles of the present disclosure; and

FIG. 2 is a perspective side view of a mounting bracket for the goose neck hinge of FIGS. 1A-1C according to the principles of the present disclosure.

### DETAILED DESCRIPTION

The following description is merely exemplary in nature and is not intended to limit the present disclosure, application or uses.

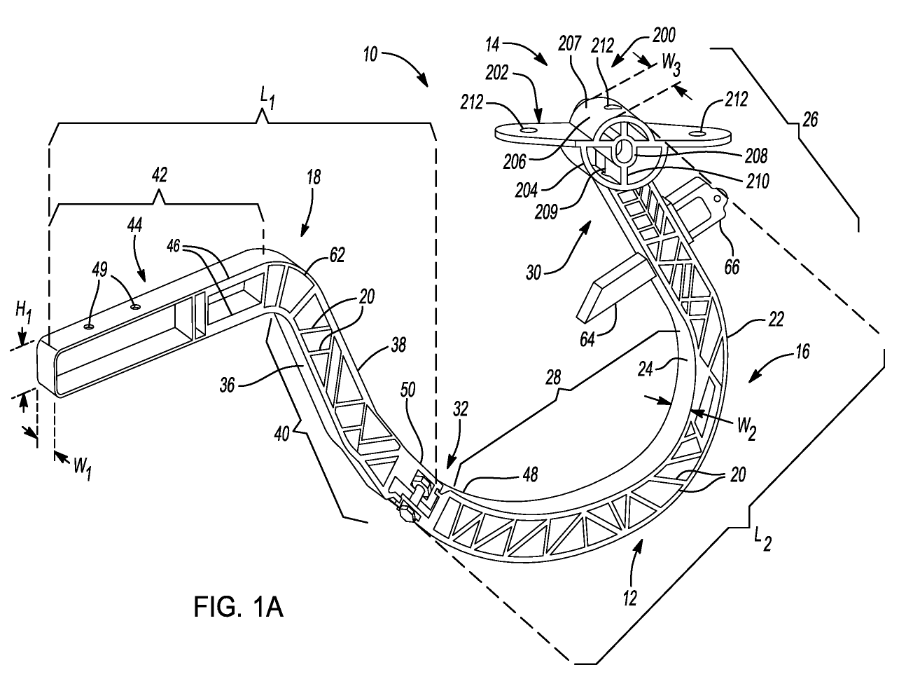

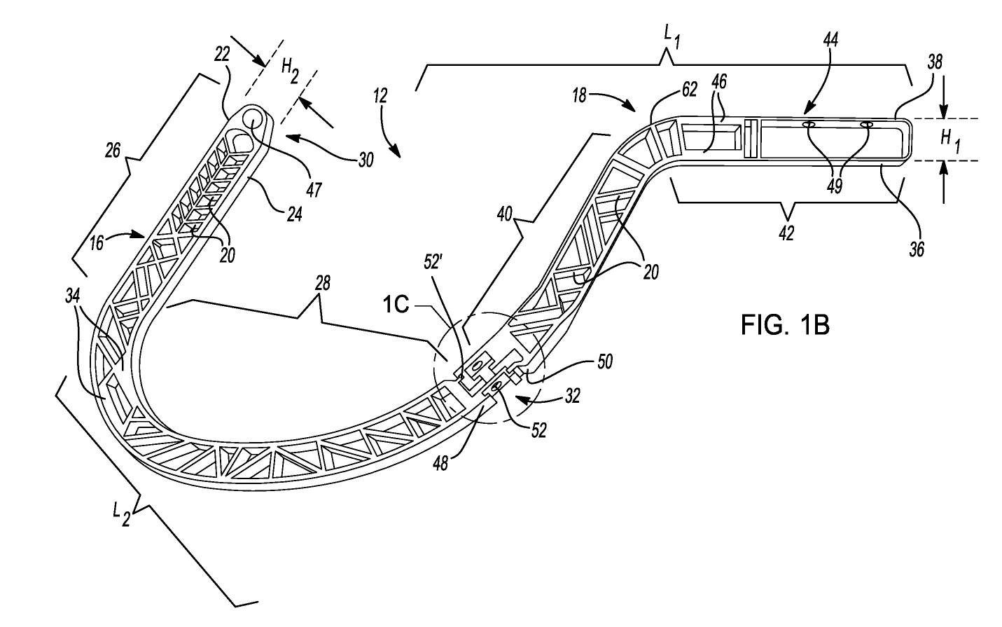

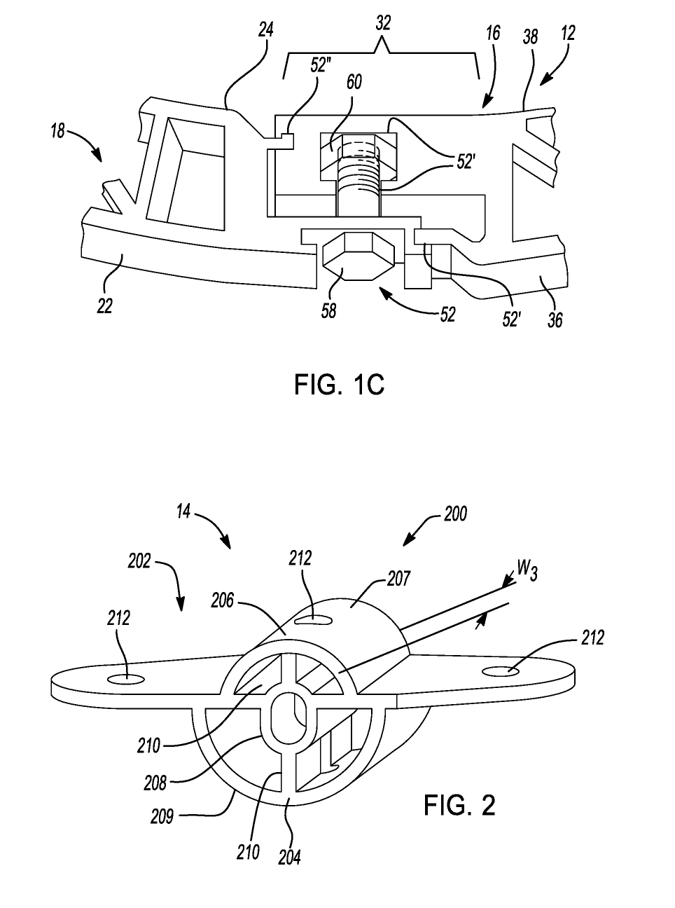

With reference to FIGS. 1A-1C, a first example of a goose neck hinge assembly is shown and generally indicated by reference number 10. The goose neck hinge assembly 10 is preferably used in a vehicle, for example a passenger vehicle, truck, sport utility vehicle, van, motor home, or any other type of vehicle without departing from the scope or intent of the present disclosure. More specifically, the goose neck hinge assembly 10 is used in a body opening or recess of the vehicle (not shown). That is, a body panel (not shown), such as a trunk lid, deck lid, hood, door, or the like is attached to a corresponding compartment (not shown) of the vehicle body by at least one, and preferably at least a pair of spaced goose neck hinge assemblies 10.

The goose neck hinge assembly 10 includes a base portion 12 having a substantially continuous curvilinear silhouette and a mounting bracket 14. The base portion 12 is rotatably engaged with the mounting bracket 14. The base portion 12 has a generally rectangular cross sectional profile and includes a first structural element 16 and a second structural element 18. In one aspect, both the first and the second structural elements 16, 18 are horizontal extrusions. The horizontal extrusions may be made of aluminum, steel, magnesium, and alloys of these, as well as polymeric or composite materials. The composition of the horizontal extrusions may vary with the intended use for the goose neck hinge assembly 10.

Additionally, both the first and the second structural elements 16, 18 include a plurality of structural ribs 20. The plurality of structural ribs 20 are optimally located to provide mechanical advantages, such as bending resistance and structural reinforcement to the goose neck hinge assembly 10 at predetermined locations. In one aspect, the structural ribs 20 are topology optimized to provide the mechanical advantages. Similarly, the shapes, sizes, and locations of the structural ribs 20 may be determined by experiment, computer-aided drafting and design, finite elemental analysis, and the like. Moreover, depending on the application for which the goose neck hinge assembly 10 is intended, the shapes, sizes, and locations of the structural ribs 20 may vary substantially. Similarly, while the base portion 12 has been described as having two structural elements, namely the first and second structural elements 16, 18, it should be understood that the base portion 12 could be one monolithic structural element, but could also have more than two structural elements without departing from the scope or intent of the present disclosure.

In an aspect, the structural ribs 20 of the first structural element 16 extend substantially across a first height “H₁” and a first width “W₁” of the first structural element 16. In other words, the structural ribs 20 may extend substantially from an outer surface 22 to an inner surface 24 of the first structural element 16. In another aspect, the structural ribs 20 of the first structural element 16 may extend for only a portion of the first height “H₁”, and/or for only a portion of the first width “W₁” of the first structural element 16, or for a substantially longitudinal aspect of the first structural element 16, etc. In yet another aspect, the shapes, relative thicknesses, and directions of the structural ribs 20 of the first structural element 16 may vary over a first length “L₁” of the first structural element 16. For example, the structural ribs 20 may approximate a series of stacked chevrons connected by a central spinal rib, and/or the structural ribs 20 may approximate any of a variety of different structural truss designs. The structural ribs 20 may also extend substantially transverse to the first height “H₁” of the first structural element 16.

The first structural element 16 also includes a first substantially straight portion 26 and a first substantially curvilinear portion 28. The first substantially straight portion 26 extends from a hinge portion 30 to the first substantially curvilinear portion 28. The first substantially curvilinear portion 28 extends from the first substantially straight portion 26 to a rotation-resisting joint 32.

In another respect, the structural ribs 20 may include first thickened areas 34 of the first structural element 16. In one example, the first thickened areas 34 of the first structural element 16 are located substantially where the first substantially straight portion 26 and the first substantially curvilinear portion 28 meet. However, it should be understood that depending on the application for which the goose neck hinge assembly 10 is intended, the first thickened areas 34 may be optimally located at varying locations along the length “L₁” of the first structural element 16. In several aspects, the location where the first substantially straight portion 26 and the first substantially curvilinear portion 28 meet is also an area where the base portion 12 approaches, and may contact the body opening (not shown) of the motor vehicle. Thus, as the goose neck hinge 16 rotates relative to the mounting bracket 14, the first thickened areas 34 provide increased robustness where the base portion 12 may contact the body opening (not shown) of the motor vehicle.

In several aspects, the structural ribs 20 of the second structural element 18 extend substantially across a second height “H₂”, and a second width “W₂” substantially equal to the first width “W₁”, of the second structural element 18. In one aspect, the second height “H₂” is substantially equal to the first height “H₁”, and the second width “W₂” is substantially equal to the first width “W₁”.

In other words, the structural ribs 20 may extend substantially from an outer surface 36 to an inner surface 38 of the second structural element 18. In another aspect, the structural ribs 20 of the second structural element 18 may extend for only a portion of the second height “H₂” and/or the second width “W₂” of the second structural element 18, or for a substantially longitudinal aspect of the second structural element 18, etc. In yet another aspect, the shapes, relative thicknesses, and directions of the structural ribs 20 of the second structural element 18 may vary over a second length “L₂” of the second structural element 18. For example, the structural ribs 20 may approximate a series of stacked chevrons connected by a central spinal rib, and/or the structural ribs 20 may approximate any of a variety of different structural truss designs. The structural ribs 20 may also extend substantially transverse to the second height “H₂” of the second structural element 18.

The second structural element 18 has a second substantially curvilinear portion 40 and a second substantially straight portion 42. The second substantially curvilinear portion 40 extends from the rotation-resisting joint 32 to the second substantially straight portion 42. The second substantially straight portion 42 extends from the second substantially curvilinear portion 40 to a panel attachment portion 44

In another respect, the structural ribs 20 may include second thickened areas 46 of the second structural element 18. In one example, the second thickened areas 46 of the second structural element 18 are optimally located to provide strength, bending resistance, durability, and robustness to at high load areas such as near the panel attachment portion 44 of the second structural element 18 of the goose neck hinge assembly 10. That is, the second thickened areas 46 are optimally located so that as the goose neck hinge assembly 10 rotates relative to the mounting bracket 14, the second thickened areas 46 provide increased robustness where the base portion 12 undergoes a torque due to the base portion 12 being attached to a movable body panel of the motor vehicle. In an example, the second thickened areas 46 are located just in front of a leading edge of the movable body panel of the motor vehicle to resist bending and deformation due to the weight of the body panel. Therefore, the second thickened areas 46 are designed to support the weight of the movable body panel while resisting deformation over time, and with repeated use.

The hinge portion 30 includes first attachment features 47 extending laterally across the first structural element 16, for attaching the base portion 12 of the goose neck hinge assembly 10 to the vehicle via a mounting bracket 14. More specifically, the first attachment features 47 are optimally shaped and sized to support a pivot member (not shown) such as a rod, pin, spring pin, or the like. Similarly, the second structural element 18 includes second attachment features 49 extending substantially vertically across the second height “H₂” of the second structural element 18 at the panel attachment portion 44. The second attachment features 49 are optimally shaped and sized for attaching the base portion 12 of the goose neck hinge assembly 10 to the deck lid of the vehicle. In one aspect, the second attachment features 49 accept mechanical fasteners (not shown) such as screws, bolts, rivets, interference fittings, and the like. In another aspect, the second attachment features 49 include adhesive materials, such as epoxies, polyurethane, polysulfide, acrylic anaerobic, cyanoacrylate, polyamide, latex and silicone elastomeric adhesives, and the like. Moreover, in some aspects, the second attachment features 49 may include both mechanical fasteners and adhesive materials. While the first attachment features 47 are described as extending laterally across the first structural element 16, and the second attachment features 49 are described as extending vertically across the second structural element 18, it should be understood that depending on the application for which the goose neck hinge assembly 10 is intended, the locations, shapes, sizes, and orientations of the first and second attachment features 47, 49 may vary. For example, if the deck lid of the motor vehicle includes a laterally-extending feature adapted to interface with the panel attachment portion 44 of the second structural element 18, the second attachment features 49 may extend laterally across the second width “W₂” of the second structural element 18 rather than across the second height “H₂”.

With reference to FIG. 10, and with continued reference to FIGS. 1A-1B, the rotation-resisting joint 32 will now be described in greater detail. As can be seen in FIG. 10, the rotation-resisting joint 32 is formed by a first end 48 of the first structural element 16, and a second end 50 of the second structural element 18. The first and second ends 48, 50 define third attachment features 52. In one aspect, the third attachment features 52 include cooperating fittings where the shape of a portion of each fitting corresponds to the shape of a portion of the other fitting for connecting the fittings together, such as tongue-and-groove elements 52′. In another aspect, the third attachment features 52 may include fittings having an interference fit where the fittings are held together by physical contact due to the dimensional characteristics of the fittings. In another aspect, the third attachment features 52 include receivers 52″ for mechanical fasteners such as combinations of bolts 58 and nuts 60, screws, rivets, and the like. In yet another aspect, the third attachment features 52 may include adhesive materials (not shown) such as epoxies, polyurethane, polysulfide, acrylic anaerobic, cyanoacrylate, polyamide, latex and silicone elastomeric adhesives, and the like. Moreover, in some aspects, the third attachment features 52 may include both mechanical fasteners and adhesive materials.

The third attachment features 52 may be formed in a single process with the rest of the first and second structural elements 16, 18 through horizontal extrusion. In another aspect, third attachment features 52 such as receivers 52″ may be formed in a second process during which the receivers 52″ are formed by drilling or tapping and threading processes. Once the third attachment features 52 have been formed, fasteners may be applied to the rotation-resisting joint 32. For example, after receivers 52″ for nuts 60 and bolts 58 have been formed in the first and second ends 48, 50 of the first and second structural elements 16, 18, a nut 60 is inserted into a first one of the receivers 52″. The receiver 52″ of the example is shaped to accept the nut 60 and prevent the nut 60 from rotating within the receiver 52″. A bolt 58 is inserted into a second one of the receivers 52″ and into threaded engagement with the nut 60. Thus, the bolt 58 and nut 60 in combination with additional third attachment features 52 lock the first and second ends 48, 50 of the first and second structural elements 16, 18 together, and prevent rotation of the first structural element 16 relative to the second structural element 18.

In several aspects, the third attachment features 52 of the first end 48 are recessed from the outer and inner surfaces 22, 24 of the first structural element 16. Similarly, the third attachment features 52 of the second end 50 are recessed from the outer and inner surfaces 36, 38 of the second structural element 18. That is, the outer and inner surfaces 22, 24, and 36, 38 of the first and second structural elements 16, 18 define inner and outer limits with respect to the extents of the third attachment features 52 forming the rotation-resisting joint 32. Thus, the third attachment features 52 and the rotation-resisting joint 32 are recessed from the substantially continuous curvilinear silhouette of the base portion 12. Therefore, the third attachment features 52 and therefore, the rotation-resisting joint 32, do not protrude from the substantially continuous curvilinear silhouette. Thus, the third attachment features 52 and rotation-resisting joint 32 are optimized to minimize interference with movement of the gooseneck hinge 10 relative to the motor vehicle. Moreover, because the third attachment features 52 and the rotation-resisting joint 32 are recessed from the substantially continuous curvilinear silhouette of the base portion 12, there is a reduced likelihood of interference with operators of the motor vehicle, and with mechanical components of deck lid assemblies, closure assemblies, body openings, or recesses within the motor vehicle.

In some aspects, once the third attachment features 52 of the first and second ends 48, 50 are engaged with, and assembled with each other, the base portion 12 of the goose neck hinge assembly 10 is manipulated into a predetermined shape. In other words, once the first and second structural elements 16, 18 are assembled with each other to form the base portion 12, the base portion 12 is manipulated into a predetermined shape. In another aspect, the first and/or second structural elements 16, 18 may be manipulated into a predetermined shape prior to the first and second ends 48, 50 being engaged with and assembled with each other. In some aspects, the predetermined shape includes a bend 62 transverse to the longitudinal aspects of the first and/or second structural elements 16, 18. The bend 62 may be formed by stretching, crush forming, crash forming, mandrel bending, stretch bending and the like. The bend 62 may be formed prior to, during, or after the first and second ends 48, 50 are assembled with each other. Depending on the application for which the goose neck hinge assembly 10 is intended to be used, the exact location, three-dimensional orientation, and angle of the bend 62 may vary. In one example, the bend 62 is located proximate to the second end 50 of the second structural element 18, and is oriented substantially vertically through the base portion 12. In another example, the bend 62 may be located proximate the panel attachment portion 44 of the second structural element 18 of the goose neck hinge assembly 10. In the example, the bend 62 is located at, or proximate to the leading edge of the movable body panel of the motor vehicle, is oriented substantially vertically through the second structural element 18, so that the panel attachment portion 44 extends out of a plane defined by the base portion 12. In a further example, two goose neck hinge assemblies 10 are used with a deck lid of a motor vehicle. The goose neck hinge assemblies 10 are located substantially at or near an outboard left edge, and an outboard right edge of the deck lid. The bend 62 of the base portion 12 of the left-most goose neck hinge assembly 10 causes the panel attachment portion 44 to extend towards a centerline of the motor vehicle. Similarly, the bend 62 of the base portion 12 of the right-most goose neck hinge assembly 10 causes the panel attachment portion 44 to extend toward the centerline of the motor vehicle. Thus, panel attachment portions 44 of the two goose neck hinge assemblies 10 may be angled inward, toward the centerline of the motor vehicle, thus allowing the deck lid to have a shape that tapers towards its rearmost edge. While the goose neck hinge assemblies 10 of the above example are angled inwardly toward one another, it should be understood that depending on the application, it may be desirable for the goose neck hinge assemblies 10 to be splayed outward, or parallel to one another instead.

The goose neck hinge assembly 10 may additionally be equipped with additional features for limiting rotational freedom of the base portion 12 relative to the motor vehicle. In one example, the additional features include first flexible bumpers 64 disposed on the inner surface 24 of the base portion 12 proximate the hinge portion 30. In the example, the first flexible bumpers 64 limit rotation of the base portion 12 relative to the motor vehicle as the goose neck hinge assembly 10 is manipulated into an open position. In another example, second flexible bumpers 66 may be equipped to the motor vehicle itself, such that as the goose neck hinge assembly 10 is manipulated into a closed position, body damage is avoided and body panel alignment is properly maintained.

Turning now to FIG. 2, and with continuing reference to FIG. 1A, the mounting bracket 14 will now be described in more detail. The mounting bracket 14 is formed via horizontal extrusion. In one aspect, the material from which the mounting bracket 14 is extruded may be aluminum, steel, magnesium, and alloys of the same, as well as polymeric or composite materials without departing from the scope or intent of the present disclosure. The mounting bracket 14 has a width “W₃”. The width “W₃” of the mounting bracket 14 may vary depending on the application for which the goose neck hinge assembly 10 is intended. The mounting bracket 14 includes a hinge section 200 and a flange section 202. The hinge section 200 is substantially cylindrical in shape. The flange section 202 extends laterally from the hinge portion 200 and is substantially planar. The hinge section 200 has a first outer section 204 that is substantially semi-circular extends out of the flange section 202. The hinge section 200 has a second outer section 206 that is also substantially semi-circular and extends out of the flange section 202 directly opposite the first outer section 204. In other words, the first and second outer sections 204, 206 form a substantially cylindrical section of the mounting bracket 14 extending out of the substantially planar flange section 202. In some aspects a radius of the first outer section 204 may differ from a radius of the second outer section 206. For example, the radius of the first outer section 204 may be smaller than the radius of the second outer section 206 due to packaging constraints, structural requirements, etc. When used with an exemplary deck lid, the mounting bracket 14 attaches to a frame of the vehicle, to the interior of a body opening of the vehicle, or the like, and the first outer section 204 forms a top surface 207 of the hinge section 200 of the mounting bracket 14, and the second outer section 206 forms a bottom surface 209 of the hinge section 200 of the mounting bracket 14.

The hinge portion 200 also has an inner portion 208 disposed concentrically within the first and second outer sections 204, 206. The inner portion 208 is supported within the first and second outer sections 204, 206 by a plurality of radially-outwardly extending strut sections 210. The inner portion 208 is optimally shaped to support a pivot member (not shown) such as a rod, pin, spring pin, or the like. The inner portion 208 may also support a spring bracket (not shown) that, for example provides a motor vehicle operator with spring assistance in opening a deck lid, and resisting closure of the deck lid. In one aspect, the inner portion 208 is substantially cylindrical in shape and has a substantially circular cross section. In another aspect, the inner portion 208 has a substantially cylindrical shape with an ovoid or “stadium” shaped cross section. A stadium shape is a rectangle having a pair of semi-circles positioned at opposite ends.

The mounting bracket 14 also includes a plurality of attachment points 212. The attachment points 212 are located in both the flange section 202 and the hinge section 200. In one aspect, the attachment points 212 are a plurality of holes for affixing the mounting bracket 14 to a vehicle via mechanical fasteners such as screws, rivets, bolts, and the like, or other bonding means such as glue, welding, braising or the like. The attachment points 212 are optimally located on the flange section 202 and the hinge section 200 for providing structural rigidity, strength, ease of assembly and robustness to the overall goose neck hinge assembly 10. In one aspect, the attachment points 212 are formed by stamping, drilling, tapping, or the like after the mounting bracket 14 has been extruded. Subsequently, the attachment points 212 are affixed to the motor vehicle body by mechanical fasteners, or other bonding means, while the hinge section 200 is rotatably connected to the base portion 12 of the goose neck hinge assembly 10 by a pivot member (not shown) such as a rod, pin, spring pin, or the like.

The goose neck hinge assembly 10 of the present disclosure offers a variety of advantages. As shown in the Mass Comparison of Table 1, relative to a generic baseline goose neck hinge assembly, the present goose neck hinge assembly 10 offers substantial weight savings not only with respect to the base portion 12, but with respect to the mounting bracket 14, and the flexible bumpers 122.

TABLE 1

| Mass Comparison | Baseline | FIGS. 1A-2 | |
|---|---|---|---|
| Total mass of System (Kg) | 1.65 | 1.13 | |
| % Mass Saved w.r.t. to Baseline | NA | 31.19 | |
| Goose Neck Hinge Link (g) | 1304 | 948 | (−27.31%) |
| Mounting Brackets (g) | 216 | 90 | (−58.33%) |
| Flexible Bumper (g) | 40 | 9 | (−77.55%) |
| Spring Bracket (g) | 85 | 85 | (0%) |

Similarly, as shown in the exemplary performance comparison data of Table 2, the goose neck hinge assembly 10 of the present disclosure offers bending resistance characteristics similar to the baseline goose neck hinge assembly.

TABLE 2

| Performance Comparison | Baseline | FIGS. 1A-2 | |
|---|---|---|---|
| Stiffness Load Case Displacement (mm) | 0.78 | 1.25 | (0.47) |
| Stiffness Load Case (N/mm) | 1149.00 | 800 | (−30%) |
| Decklid Loadcase X-Z (mm) | 0.78 | 1.25 | (0.47) |
| Decklid Loadcase Y-Z (mm) | 1.32 | 1.6 | (0.28) |

Thus, for example, the goose neck hinge assembly 10 of FIGS. 1A-2 offers greater than 25% weight savings over the baseline while substantially maintaining bending resistance, stiffness, and strength. Depicted in another manner in Table 3, the goose neck hinge assemblies 10 of FIGS. 1A-2 offer substantial weight savings while reducing materials costs and maintaining performance and process targets.

TABLE 3

| | Mass | Tooling | Piece | | | | |
|---|---|---|---|---|---|---|---|
| | Save | Cost | Cost | Integration | | | |
| Pugh | Weighting | Weighting | Weighting | Weighting | | | % |
| Matrix | (2) | (1) | (1) | (2) | Total | Mass | Difference |
| Baseline | 0 | 0 | 0 | 0 | 0 | 1304.094 | 0 |
| FIGS. 1A-2 | 2 | 0 | −1 | 2 | 3 | 948 | −27.31% |

More specifically, Table 3 depicts a Pugh Matrix in which mass weight savings are given a weighting of 2, and tooling costs, piece costs, and integration are each given a weighting of 1. Overall, because of the relative ease of manufacture, and decreased weight, the goose neck hinge assembly 10 of the present disclosure is better suited to the optimization criteria, relative to the baseline goose neck hinge. Thus, a goose neck hinge assembly 10 of the present disclosure offers several advantages including scalability, portability, durability, robustness, strength, and light weight, all while increasing ease of manufacture, lowering cost, and minimizing the number of independent assembly steps required.

The description of the present disclosure is merely exemplary in nature and variations that do not depart from the gist of the present disclosure are intended to be within the scope of the present disclosure. Such variations are not to be regarded as a departure from the spirit and scope of the present disclosure.

The following is claimed:

1. A goose neck hinge assembly for a motor vehicle, the goose neck hinge assembly comprising:
a base portion extending from a panel attachment portion to a hinge portion, wherein the base portion includes a rotation-resisting joint,
wherein the base portion includes a first structural element with first structural ribs, wherein the first structural element is joined at the rotation-resisting joint to a second structural element, wherein the second structural element includes second structural ribs, wherein the first structural ribs and the second structural ribs are topology optimized providing bending resistance and structural reinforcement at predetermined locations, wherein the rotation-resisting joint includes a recessed fastener, and wherein the first structural element extends from the hinge portion to the rotation-resisting joint and the second structural element extends from the rotation-resisting joint to the panel attachment portion.

2. The goose neck hinge assembly of claim 1 wherein both the first structural element and the second structural element comprise horizontal extrusions bent into a predetermined shape.

3. The goose neck hinge assembly of claim 2 wherein the predetermined shape includes a lateral bend.

4. The goose neck hinge assembly of claim 2 wherein the horizontal extrusions are made from aluminum.

5. The goose neck hinge assembly of claim 1 wherein the first structural element has a first substantially straight portion and a first substantially curvilinear portion, and wherein the first substantially straight portion extends from the hinge portion to the first substantially curvilinear portion and the first substantially curvilinear portion extends from the first substantially straight portion to the rotation-resisting joint, and wherein the second structural element has a second substantially curvilinear portion and a second substantially straight portion, and wherein the second substantially curvilinear section extends from the rotation-resisting joint to the second substantially straight portion and the second substantially straight portion extends from the second substantially curvilinear portion to the panel attachment portion.

6. The goose neck hinge assembly of claim 1 wherein the first structural ribs and the second structural ribs extend substantially from a lower surface to an upper surface of the base portion.

7. The goose neck hinge assembly of claim 1 wherein the first structural ribs comprise a first thickened area and the second structural ribs further comprise a second thickened area, wherein the first thickened area and the second thickened area are optimally located to provide structural reinforcement.

8. The goose neck hinge assembly of claim 7 wherein the first structural ribs of the first substantially curvilinear portion approximate a plurality of trusses extending substantially from the first substantially straight portion to the first thickened area and from the first thickened area to the rotation-resisting joint, and wherein the second structural ribs of the second substantially curvilinear portion approximate a plurality of trusses extending substantially from the rotation-resisting joint to the second straight portion.

9. The goose neck hinge assembly of claim 7 wherein the second structural ribs of the second substantially straight portion include a plurality of supports transverse to a longitudinal aspect of the second substantially straight portion, and wherein the second structural ribs extend from the second substantially curvilinear portion to the second thickened area and from the second thickened area to the panel attachment portion.

10. The goose neck hinge assembly of claim 7 wherein the second thickened area is optimally located to provide structural reinforcement where the second substantially straight portion of the goose neck hinge assembly abuts the second substantially curvilinear portion.

11. The goose neck hinge assembly of claim 1 wherein the recessed fastener includes at least one of an adhesive, or a mechanical fastener.

12. The goose neck hinge assembly of claim 1 wherein the rotation-resisting joint includes a recessed area accepting and providing rotation resistance to a mechanical fastener.

13. The goose neck hinge assembly of claim 12 wherein the rotation resisting joint further comprises a first cooperating fitting and a second cooperating fitting wherein a first shape of a portion of each of the first cooperating fitting and the second cooperating fitting corresponds to a second shape of a portion of the other cooperating fitting for connecting the first cooperating fitting and the second cooperating fitting together.

14. The goose neck hinge assembly of claim 13 wherein the mechanical fastener comprises at least one of an interference joint, a bolt, a bolt and a nut, a pin, a spring pin, or a pin with rolled over ends.

15. The goose neck hinge assembly of claim 1 further comprising a mounting bracket mounted to the motor vehicle and rotatably connected to the hinge portion of the base portion by a hinge pin.

16. The goose neck hinge assembly of claim 15 wherein the mounting bracket is a metal extrusion or casting having an inner substantially cylindrical component concentrically and integrally extruded with an outer substantially cylindrical component and a substantially planar flange, wherein the inner substantially cylindrical component accepts the hinge pin and the outer substantially cylindrical component is connected to the inner substantially cylindrical component by a plurality of radial ribs, and wherein the substantially planar flange extends radially outward from the outer substantially cylindrical component and has a plurality of attachment features attaching the mounting bracket to the motor vehicle.

17. A goose neck hinge assembly for a motor vehicle, the goose neck hinge assembly comprising:
a base portion extending from a panel attachment portion to a hinge portion, wherein the base portion includes a rotation-resisting joint; and
a mounting bracket mounted to the motor vehicle, and rotatably connected to the hinge portion of the base portion by a hinge pin,
wherein the base portion includes a first horizontally extruded structural element with first structural ribs, wherein the first horizontally extruded structural element is joined at the rotation-resisting joint to a second horizontally extruded structural element, wherein the second horizontally extruded structural element includes second structural ribs, wherein the first structural element and the second structural element are topology optimized providing bending resistance and structural reinforcement at predetermined locations, wherein the rotation-resisting joint includes a recessed fastener, and wherein the first horizontally extruded structural element extends from the hinge portion to the rotation-resisting joint and the second horizontally extruded structural element extends from the rotation-resisting joint to the panel attachment portion, and wherein the mounting bracket is an extrusion having a substantially cylindrical component integrally extruded with a substantially planar flange, wherein the substantially cylindrical component accepts the hinge pin, and wherein the substantially planar flange extends radially outward from the substantially cylindrical component and has a plurality of attachment features for attaching the mounting bracket to the motor vehicle.

18. The goose neck hinge assembly of claim 15 wherein the first structural ribs and the second structural ribs extend for a portion of a height of the base portion.

19. The goose neck hinge assembly of claim 16 wherein the first structural ribs and the second structural ribs extend substantially from a lower surface to an upper surface of the base portion.

20. A goose neck hinge assembly for a motor vehicle, the goose neck hinge assembly comprising:
a goose neck strap comprising a plurality of horizontally extruded structural elements, a first of the plurality of horizontally extruded structural elements secured at a rotation-resisting joint to a second of the plurality of horizontally extruded structural elements, wherein the goose neck strap extends from a panel attachment portion to a hinge portion; and
a mounting bracket mounted to the motor vehicle, and rotatably connected to the hinge portion of the goose neck strap by a hinge pin,
wherein the first of the plurality of horizontally extruded structural elements extends from the hinge portion to the rotation-resisting joint and the second of the plurality of horizontally extruded structural elements extends from the rotation-resisting joint to the panel attachment portion, and wherein the first of the plurality of horizontally extruded structural elements includes first topology optimized structural ribs, and the second of the plurality of horizontally extruded structural elements includes second topology optimized structural ribs, and wherein the rotation-resisting joint includes a recessed fastener, and wherein the mounting bracket is a metal extrusion having substantially cylindrical component integrally extruded with a substantially planar flange, wherein the substantially cylindrical component accepts the hinge pin, and wherein the substantially planar flange extends radially outward from the substantially cylindrical component and has a plurality of attachment features for attaching the mounting bracket to the motor vehicle.
